(19) United States
(12) Patent Application Publication
(10) Pub. No.: US 2025/0256209 A1
(43) Pub. Date: Aug. 14, 2025

(54) SYSTEMS, METHODS, AND DEVICES TO GENERATE CUSTOMIZABLE THREE- DIMENSIONAL (3D) VIRTUAL ENVIRONMENTS

(71) Applicant: OBSESS, INC., New York, NY (US)

(72) Inventors: Neha Singh, New York, NY (US); John Mann, New York, NY (US); Hiran Gnanapragasam, New York, NY (US)

(73) Assignee: OBSESS, INC., New York, NY (US)

(21) Appl. No.: 18/441,396

(22) Filed: Feb. 14, 2024

(51) Int. Cl. A63F 13/63; A63F 13/537

(52) U.S. Cl. CPC A63F 13/63; A63F 13/537

(57) ABSTRACT

Systems, methods, and devices provide virtual, three-dimensional, interactive environments by using a template user interface which defines multiple customizable parameters. An environment generator engine generates a customizable three-dimensional (3D) virtual environment by rendering a 3D model and applying one or more interactive features defined by the customizable parameters. These interactive features can include avatar features, product model features, game features, and/or environment features Additionally, product models are mapped to one or more virtual surfaces of the 3D model based on the customization parameters. The system also causes the virtual interactive environment to be presented, at a display of a user device, and receives user input(s) controlling the virtual avatar to browse the customizable 3D virtual environment.

### FIELD

Aspects of the presently disclosed technology relate generally to systems and methods for generating interactive three-dimensional virtual environments for product interaction and virtual experience and more particularly to a customization system for a virtual environment BACKGROUND

Many retailers would like to present their own, custom, virtual store on their own site. However, engaging virtual environments with sophisticated browsing and shopping features are difficult to build. Cost constraints can prevent many retailers from investing in developing their own virtual stores in-house. These virtual stores typically use a scrollable list of images and drop-down browsing structure with little focus on recreating the nuances of a brick-and-mortar shopping experience. Furthermore, it can be difficult to match the features and styles of an interactive environment to a particular brand while keeping the environments updated and engaging as companies grow and change.

It is with these observations in mind, among others, that various aspects of the present disclosure were conceived and developed.

### SUMMARY

Implementations described and claimed herein address the foregoing problems by providing systems, methods, and devices for providing a virtual interactive environment. For instance, a method can include providing, with an environment generator engine, a template user interface for creating a customizable three-dimensional (3D) virtual environment; receiving, with the environment generator engine, one or more inputs which sets one or more customizable parameters of the template user interface, the one or more customizable parameters of the template user interface corresponding to interactive features of the customizable 3D virtual environment, and the interactive features include at least one of an avatar feature, a product model feature, or a game feature; and/or causing the virtual interactive environment to be presented, at one or more displays of one or more guest computing devices accessing the customizable 3D virtual environment, as a virtual avatar navigable in a computer-generated 3D space with the interactive features corresponding to the one or more customizable parameters.

In some examples, the method can include receiving a navigation-specific input; and/or cycling between a plurality of predefined location coordinates of the customizable 3D virtual environment responsive to the navigation-specific input. The method can also include presenting a mini-map portion at a graphical user interface (GUI) of the one or more guest computing devices; detecting an interaction with the mini-map portion of the GUI; and/or causing an avatar location to change to a predefined location coordinate corresponding to the interaction with the mini-map portion of the GUI. The one or more customizable parameters can control the interactive features including a 3D model rendered to form a virtual structure, a virtual building, or a virtual room. Also, the 3D model can define the computer-generated 3D space of the customizable 3D virtual environment. Moreover, the environment generator engine can receive the one or more input at a moderator computing device which hosts the computer-generated 3D space for the one or more guest computing devices accessing the customizable 3D virtual environment.

In some instances, the one or more customizable parameters can include one or more product models mapped to one or more virtual surfaces of the computer-generated 3D space. Furthermore, the one or more product models can include a link which, responsive to receiving a user interaction, can cause a computing device hosting the customizable 3D virtual environment to retrieve product data related to the one or more product models stored at a product information database; and/or cause the product data to be presented at the one or more guest computing devices overlayed onto the customizable 3D virtual environment. Additionally, the one or more customizable parameters can control one or more of a lighting source layer, a reflective material layer, and/or a texture layer mapped to a 3D model to define the computer-generated 3D space. The one or more customizable parameters can also include a first set of avatar customization parameters selected to be mutable by the one or more input, and a second set of avatar customization parameters selected to be immutable by the one or more input.

In some scenarios, a system for providing a virtual interactive environment can include one or more processors; and/or a computer-readable memory device storing instructions that, when executed by the one or more processors, cause the system to provide, with an environment generator engine, a template user interface for creating a customizable computer-generated 3D virtual environment; receive, with the environment generator engine, one or more input which sets one or more customizable parameters of the template user interface, the one or more customizable parameters of the template user interface corresponding to a plurality of interactive features of the customizable 3D virtual environment, and the plurality of interactive features can include an avatar feature, a product model feature, and a game feature; and/or the instructions can cause the virtual interactive environment to be presented, at one or more displays of one or more guest computing devices accessing the customizable 3D virtual environment, as a virtual avatar navigable in a computer-generated 3D space with the plurality of interactive features corresponding to the one or more customizable parameters.

In some examples, the instructions, when executed by the one or more processors, can further cause the system to receive an environment input from one or more sensors of the one or more guest computing devices, the environment input indicating a real world spatial surrounding of the one or more guest computing devices, the computer-generated 3D space representing the environment input overlayed with the plurality of interactive features. Additionally, the game feature can include a tile-flipping memory game integrated into the customizable 3D virtual environment, and the one or more customizable parameters can further include: a number of tiles of the tile-flipping memory game; one or more images disposed on one or more tiles of the tile-flipping memory game; and/or a visual indicator of a prize associated with successful completion of the tile-flipping memory game. Furthermore, the game feature can include a virtual claw-machine game integrated into the customizable 3D virtual environment, and the one or more customizable parameters can include a plurality of images or virtual objects, corresponding to a plurality of virtual prizes; and/or a visual indicator associated with a successful completion of the virtual claw-machine game. The game feature can also include a virtual scavenger hunt game integrated in the customizable 3D virtual environment, and the one or more customizable parameters can include one or more images or objects uploaded to the environment generator engine; one or more hidden object locations coordinates, selected with the one or more input, associated with the one or more images or objects; and/or a visual indicator associated with a successful completion of the virtual scavenger hunt game.

In some instances, a system for providing a virtual interactive environment can include one or more processors; and/or a computer-readable memory device storing instructions that, when executed by the one or more processors, cause the system to provide, with an environment generator engine, a template user interface for creating a customizable computer-generated 3D virtual environment; receive, with the environment generator engine, one or more input which sets a plurality of customizable parameters of the template user interface, the plurality of customizable parameters of the template user interface corresponding to a plurality of interactive features of the customizable 3D virtual environment; and/or cause the virtual interactive environment to be presented, at a plurality of displays of a plurality of guest computing devices accessing the customizable 3D virtual environment, as a plurality of different virtual avatars corresponding to the plurality of guest computing devices, the plurality of different virtual avatars being navigable in a computer-generated 3D space of the computer-generated 3D virtual environment including the plurality of interactive features.

In some examples, the template user interface can include an avatar customization parameters interface representing different portions of an avatar, and the plurality of customizable parameters can include customized sets of selectable avatar features that correspond to the different portions of the avatar. Furthermore, the plurality of interactive features can include a guide avatar and the plurality of customizable parameters can include one or more of images or objects associated with product data, uploaded to the environment generator engine, for outputting by the guide avatar in the customizable 3D virtual environment responsive to an interaction with a virtual avatar of the plurality of different virtual avatars; and/or one or more predefined location coordinates of the customizable 3D virtual environment for navigating the guide avatar responsive to the interaction with the virtual avatar. Additionally, the instructions, when executed by the one or more processors, can further cause the system to determine a user preference from a database storing user profile information associated with a user of a guest computing device; and/or determine a customizable parameter based at least partly on the user preference, the customizable parameter corresponding to a content file rendered at a surface in the customizable 3D virtual environment.

In some examples, the instructions, when executed by the one or more processors, can further cause the system to create, using a generative AI content engine, a plurality of selectable options for a customizable parameter, the template user interface including a user interface portion presenting the plurality of selectable options. Furthermore, the plurality of selectable options can define a customizable parameter which determines a 3D model virtual building structure, a room arrangement, a color scheme, a wallpaper design, a surface texture, a virtual architectural features, or a lighting arrangement.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for providing a customizable 3D virtual environment with an environment generator engine.

FIG. 2 illustrates an example system for providing a customizable 3D virtual environment with a merchant system and/or a guest system, which can form at least a portion of the system of FIG. 1.

FIG. 3 illustrates an example system for providing a customizable 3D virtual environment with an environment generator engine and navigation feature(s) which can form at least a portion of the system of FIG. 1.

FIGS. 4A-4C illustrates an example system for providing a customizable 3D virtual environment with an environment generator engine including an avatar settings customization engine, which can form at least a portion of the system of FIG. 1.

FIG. 5 illustrates an example system for providing a customizable 3D virtual environment with an environment generator engine including product model parameter(s), which can form at least a portion of the system of FIG. 1.

FIGS. 6A and 6B illustrates an example system for providing a customizable 3D virtual environment with an environment generator engine including a game creation engine, which can form at least a portion of the system of FIG. 1.

FIG. 7 illustrates an example system for providing a customizable 3D virtual environment with an environment generator engine including customizable environment features, which can form at least a portion of the system of FIG. 1.

FIG. 8 illustrates an example system for providing a customizable 3D virtual environment with an environment generator engine using one or more computing devices, which can form at least a portion of the system of FIG. 1.

FIG. 9 illustrates an example method for providing a customizable 3D virtual environment using an environment generator engine, which can be performed by the system of FIG. 1.

### DETAILED DESCRIPTION

Aspects of the present disclosure involve systems, methods, and devices for generating a customizable 3D virtual interactive environment based on a template user interface having a plurality of customizable parameters. Using the techniques discussed herein, an environment generator engine of a virtual environment platform can provide, to a merchant and/or moderator device, a template for customizing their own guest-facing virtual environments. The merchant and/or moderator systems can control the various aspects of the virtual environment by setting customizable parameters related to different interactive features. These interactive features can include avatar features of avatars created by the guest devices; product model features related to representations of products in the virtual 3D space; game features related to various games integrated into the virtual 3D space; and/or environment features related to structures, buildings, rooms, colors, textures, etc. which define the virtual 3D space. As such, the virtual environment platform can seamlessly integrate different types of data and files representing different aspects of the virtual world by using a simple and efficient template user interface presented at the merchant/moderator device, resulting in an engaging user experience unique to and customized for a particular entity or brand. Furthermore, the virtual 3D space can have a data structure compatible with other third-party virtual environments (e.g., games such as massive multiplayer online worlds), and can be used to form a store/environment within the game, a virtual pop-up, and/or other environments integrated into a third-party platform.

These techniques can also increase the efficiency of the data storage and retrieval processes used to create the virtual interactive environment, reduce the lag time for rendering the virtual interactive environment, and can maintain a high resolution. Moreover, the different layers of parameter control provided at the platform level, the merchant/moderator level, or the guest system level can provide uniquely customized environments for a wide variety of different entities. Different 3D models, avatar profile templates, virtual structures, virtual interior decorations, games, and so forth can be customized for the different merchants/moderators to closely tie visual features and experiences of the virtual world to the requirements of that particular entity.

Furthermore, the environment generator engine can integrate with multiple different types of merchant platforms and databases (e.g., via an API integration process) to provide updated product information in the virtual environment, for instance, on a weekly, daily, hourly, or minute-by-minute basis. The virtual environment can be hosted by a merchant or moderator site and/or can integrate with any merchant or moderator platform to provide an accurate depiction of their product data in a more engaging environment than typical ecommerce sites. Additional advantages will become apparent from the disclosure herein.

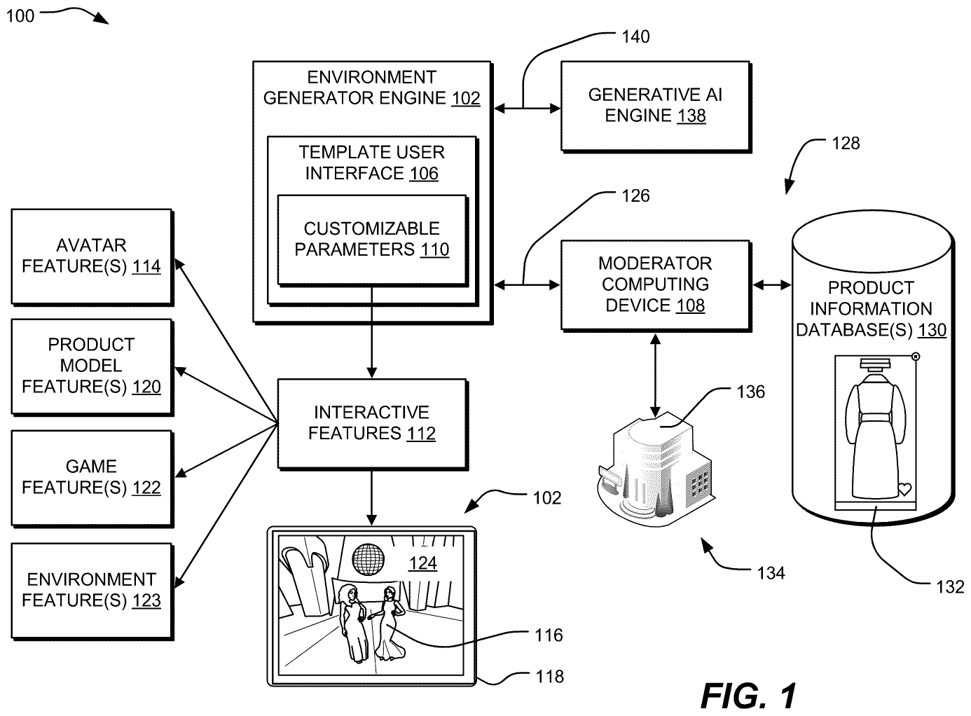

FIG. 1 illustrates an example system 100 including an environment generator engine 102 for providing a customizable 3D virtual environment 104. The environment generator engine 102 can provide a template user interface 106 to a moderator computing device 108, such that the moderator computing device 108 can provide inputs/selections for a plurality of customizable parameters 110. These customizable parameters 110 can define the interactive features 112 that form the customizable 3D virtual environment 104. By providing inputs which establish settings for the customizable parameters 110, the merchant/moderator associated with the moderator computing device 108 can use the environment generator engine 102 to customize their own guest-facing virtual environments (e.g., the customizable 3D virtual environment 104).

In some examples, these interactive features 112 controlled by the customizable parameters 110 can include one or more avatar feature(s) 114 that define which avatar options are available for avatars 116 created by one or more guest computing devices 118. The interactive features 112 can also include one or more product model feature(s) 120 to define the representations of products and objects in the customizable 3D virtual environment 104. Furthermore, the interactive features 112 can include one or more game feature(s) 122 related to various games integrated into the customizable 3D virtual environment 104. Additionally, the interactive features 112 can include one or more environment feature(s) 123 related to structures, buildings, rooms, colors, textures, and other visual aspects of the computer-generated 3D space 124 of the customizable 3D virtual environment 104.

Furthermore, the moderator computing device 108 can provide different types of inputs 126 to the environment generator engine 102 from different data sources 128. The moderator computing device 108 can access one or more product information database(s) 130 specific to the particular merchant, moderator, and/or entity associated with the moderator computing device 108. For instance, the product information database(s) 130 can store product information 132 for the merchant/moderator/entity, and can be a private database that is secured, encrypted, and/or has special permissions to store and/or retrieve the product information 132. As discussed in greater detail below, the product information 132 can be retrieved by the moderator computing device 108 and uploaded to the template user interface 106 to set the customizable parameter 110, such as the avatar feature(s) 114, the product model feature(s) 120, the game feature(s) 122, and/or the environment feature(s) 123.

In some scenarios, the moderator computing device 108 can upload one or more content file(s) 134 to the template user interface 106 to set the customizable parameters 110. The content file(s) 134 can be a 3D model 136 which defines a virtual structure or object. Additionally or alternatively, the content file(s) 134 can include one or more of an image, a video, an audio file, other 3D models 136, a 3D object, a text, and/or a setting pre-configuration. The content file(s) 134 can be stored at the product information database(s) 130 and/or other databases accessible to the moderator computing device (e.g., local databases, cloud-based remote databases, or so forth).

Additionally, in some instances, the environment generator engine 102 can receive inputs from a generative artificial intelligence (AI) engine 138. These generative inputs 140 can be created by the generative AI engine 138 to create one or more selectable options for the customizable parameters 110. For example, the generative AI engine 138 can create, as the generative inputs 140, one or more of a randomized or AI-generated 3D model 136, image, virtual building structure, room arrangement, color scheme, wallpaper design, surface texture, virtual architectural feature, or lighting arrangement. These generative inputs 140 can be presented by the template user interface 106 as an option or a set of options selectable by the moderator computing device 108.

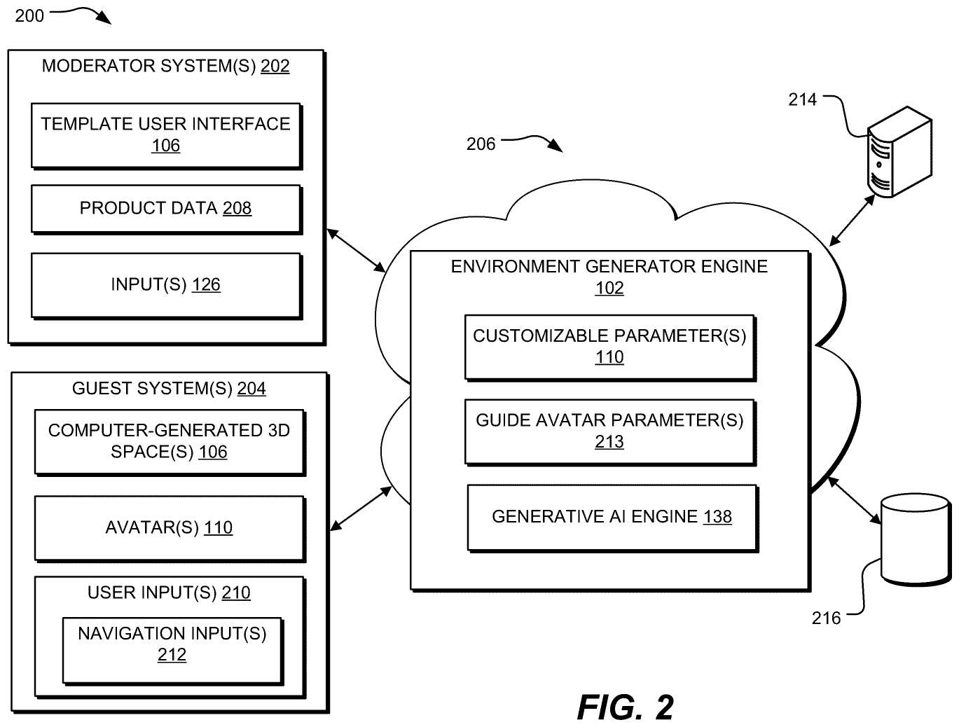

FIG. 2 depicts an example system 200 including the customizable 3D virtual environment 104 created by the environment generator engine 102. As depicted in FIG. 2, the system 200 can include one or moderator system(s) 202 and/or one or more guest system(s) 204 interacting with the customizable 3D virtual environment 104 via one or more network(s) 206 forming a network environment. The system 200 depicted in FIG. 2 can be similar to, identical to, and/or can form at least a portion of the system 100 depicted in FIG. 1.

In some examples, data files discussed herein can be sent between the environment generator engine 102 and the merchant system(s) 202 and/or guest systems 204 to provide the template user interface 106 to the moderator computing device 108; and to provide the customizable 3D virtual environment 104 to the guest computing device(s) 118. The merchant system(s) 202 can be one or more computing devices (e.g., the moderator computing device 108) associated with and/or located at a merchant or moderator entity. The merchant system(s) 202 can be associated with a wide variety of types of entities, such as a cosmetic merchant type entity, a clothing merchant type entity, a jewelry merchant type entity, a consumer electronics type entity, a retailer type entity, a shoe type entity, a luxury brand type entity, a food brand type entity, a media or television type entity, a media production type entity, a video game production or distribution type entity, an event planning type entity, combinations thereof, and so forth. The merchant system(s) 202 can interact with the environment generator engine 102 by establishing a network connection with the environment generator engine 102 via the network(s) 206 and/or downloading data files from the environment generator engine 102. In some instances, the template user interface 106 can be presented at the computing devices of the merchant system(s) 202 (e.g., via a first web portal, a plug-in, a downloadable application, etc.) for providing information to merchant personnel, and/or to receive input from the merchant system(s) 202 dictating the customizable parameters 110 of the customizable 3D virtual environment 104.

Additionally, in some instances, the merchant system(s) 202 can store and/or upload product data 208 (e.g., including the product information 132) related to the merchant or moderator from the product information database 130, such as a product model, a product description, product specifications, product price, product reviews, product images, product videos, and the like. The product data 208 can be sent from the merchant system(s) 202 to the environment generator engine 102 via the network(s) 206 (e.g., by manually uploading and/or via one or more API calls). For instance, the product data 208 can update periodically (e.g., hourly, daily, weekly, seasonally, etc.) from a product information feed of the merchant system(s) 202. The product data 208 can include one or more comma-separated values (CSV) files. Furthermore, the product data 208 can include one or more links or integrations with a cart/payment/transaction page associated with the moderator computing device 108, such that an interaction (e.g., input 210) at the product data 208 in the customizable 3D virtual environment 104 causes the guest computing device 118 to be redirected to the cart/payment/transaction page.

The system 200 can also comprise the guest system(s) 204. The guest systems 204 can include one or more user devices (e.g., the guest computing device 118) for accessing and interacting with the customizable 3D virtual environment 104. The interactive features 112 can be presented at the device(s) of the guest systems 204, for receiving one or more user input(s) 210, such as navigation inputs 212, selection inputs, or other interactions with the interactive features 112. Additionally, the user inputs 210 received at the guest systems 204 can be used to zoom in or out, change a viewing angle, and/or interact (e.g., select, hover over, etc.) with the avatar features 114, the product model features 120, the game features 122, and/or the environment features 123.

Moreover, in some scenarios, the environment generator engine 102 includes one or more guide avatar parameter(s) 213 for facilitating a guided session in the computer-generated 3D space 124 (e.g., a “guided mode” or a “curated mode”). The guide avatar parameter(s) 213 can include a particular subset of the product information 132, the content file(s) 134, location coordinates, and/or any of the interactive features 112 discussed herein, which can be used to provide a curated or guided version of the computer-generated 3D space 124. For example, the guide avatar parameter(s) 213 can include a particular set of product models or rooms that an AI-based (e.g., non-human controlled) avatar in the computer-generated 3D space 124 presents to the other, human-controlled avatar(s) 116. The guide avatar parameter(s) 213 can be customized via the customizable parameters 110 to provide a variety of different guided modes. For example, the customizable parameters 110 can include a training data set corresponding to a particular user profile (e.g., an influencer provide), such that the guide avatar parameter(s) 213 correspond to preferences of the particular user profile as a trained model. Moreover, the guide avatar parameter(s) 213 can be configured for use in response to detecting a particular identifier associated with a particular guest computing device 118, such that the guided mode is personalized to a single user or group of users (e.g., a VIP user, a celebrity user, an influence user, friends thereof, and/or combinations thereof), and is activated when that user or group of users enters the customizable 3D virtual environment 104.

In some scenarios, the environment generator engine 102, the merchant system(s) 202 and/or the guest systems 204 can communicate with each other via network connections provided by the network(s) 206. The network(s) 206 can include any type of network, such as the Internet, an intranet, a Local Area Network (LAN), a Wide Area Network (WAN), a Virtual Private Network (VPN), a Voice over Internet Protocol (VoIP) network, a wireless network (e.g., Bluetooth), a cellular network (e.g., 4G, LTE, 5G, etc.), a satellite network, combinations thereof, etc. The network 206 can include a communications network with numerous components such as, but not limited to gateways routers, servers, and registrars, which enable communication across the network 206. In one implementation, the communications network(s) includes multiple ingress/egress routers, which may have one or more ports, in communication with the network 206. Communication via any of the networks 206 can be wired, wireless, or any combination thereof. In some scenarios, the merchant system(s) 202 can interact with the environment generator engine 102 via a first network connection (e.g., a first WAN connection); and the guest systems 204 can interact with the customizable 3D virtual environment 104 via a second network connection (e.g., a second WAN connection) which is different network connection than the first network connection. Additionally, the moderator computing device 108 can interact with various databases (e.g., the product information database(s) 130) via one or more third network connection(s) (e.g., a LAN). The specialized arrangement of computing components and network interfaces disclosed herein can form a network architecture for providing the environment generator engine 102 and the customizable 3D virtual environment which improves network resource utilization (e.g., data storage, traffic volumes, CPU requirements, and/or upload/download times), thus improving the technical field of network architectures.

In some examples, the environment generator engine 102 includes one or more databases 214 for storing the data files and/or software instructions discussed herein. The environment generator engine 102 can also include one or more server devices 216 for performing operations of the environment generator engine 102 (e.g., by accessing the data stored in the one or more databases 214 and/or executing algorithms). The one or more databases 214 and/or the one or more server devices 216 can form at least a portion of a third-party system or provider of the environment generator engine 102 (e.g., separate from the merchant system 202 and the guest systems 204). Additionally or alternatively, the database(s) 214 and/or server device(s) 216 can be implemented as at least part of the merchant system(s) 202 or guest system(s) 204.

Furthermore, the various engines and user interfaces discussed herein can be retrieved from the one or more databases 214 to present at the merchant system(s) 202 or guest system(s) 204. In some examples, the one or more server devices 216 can host the customizable 3D virtual environment 104 as a web portal using data stored at the one or more databases 214, such that any guest systems 204 accessing the web portal can access the computer-generated 3D space 124. The one or more server devices 216 may be a single server, a plurality of servers with each such server being a physical server or a virtual machine, or a collection of both physical servers and virtual machines. In another implementation, a cloud service hosts one or more components of the system 200. Additionally or alternatively, the guest systems 204 can access the customizable 3D virtual environment 104 hosted at one or more servers 26 of the merchant system(s) 202. The one or more server devices 216 may represent an instance among large instances of application servers in a cloud computing environment, a data center, or other computing environment.

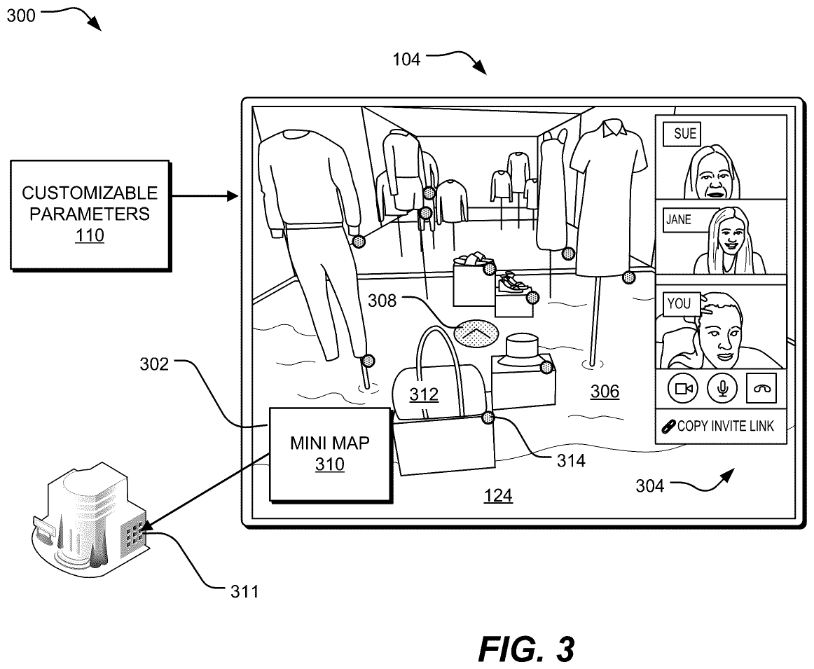

FIG. 3 depicts an example system 300 including the customizable 3D virtual environment 104 created by the environment generator engine 102. As depicted in FIG. 3, the customizable 3D virtual environment 104 can include one or more navigation features 302, which can be defined by the customizable parameter(s) 110. The system 300 depicted in FIG. 3 can be similar to, identical to, and/or can form at least a portion of the system 100 depicted in FIG. 1.

In some examples, the environment generator engine 102 can include one or more overlay features 304 presented at the UI 306 which do not form part of the 3D space 124. For instance, the one or more overlay features 304 can include a one or more navigation arrows 308 and/or a mini-map 310. The mini-map 310 can include a representation of a building or layout of the 3D space 124, and a selection at the mini-map 310 can cause the avatar 116 to teleport to a mapped location 311 in the customizable 3D virtual environment 104 associated with and/or mapped to the selected portion of the mini-map 310. Furthermore, the mini-map 310 can also present locations of other avatars 116 associated with other guest computing devices 118, and/or a guide avatar associated with the guide avatar parameters 213.

Additionally, the one or more navigation features 302 can include a navigation input 212 to rapidly move between different location coordinates (e.g., navigation arrows 308). For instance, a particular input, button, combination of inputs, and/or combination of buttons (e.g., holding alt and pressing an arrow key on a keyboard, or a tap and hold input for a touchscreen) can cause the avatar 116 to move (e.g., teleport) through a sequence of location coordinates.

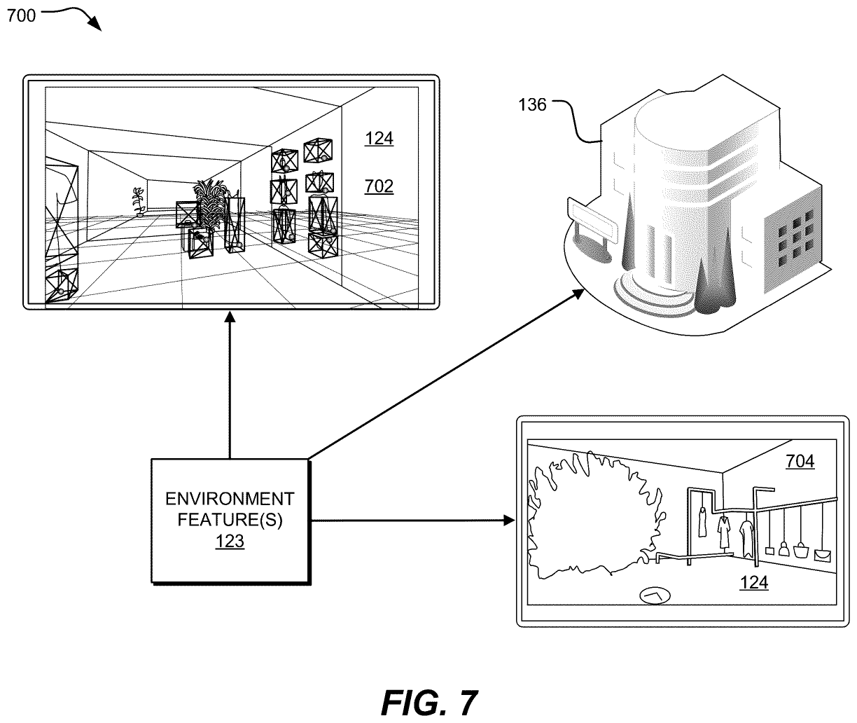

As shown in FIG. 3, the customizable 3D virtual environment 104 can also include one or more 3D product models 312 positioned at location coordinates 314 in the rendered reproduction of the 3D model 136. For instance, the computer-generated 3D space can include a reconstructed rendering of the 3D model 136. The reconstructed rendering can include a conversion of the 3D model 136 into a plurality of two dimensional images, which are reconstructed into a plurality of cube maps. These environment feature(s) 123 are discussed in greater detail below regarding FIG. 7.

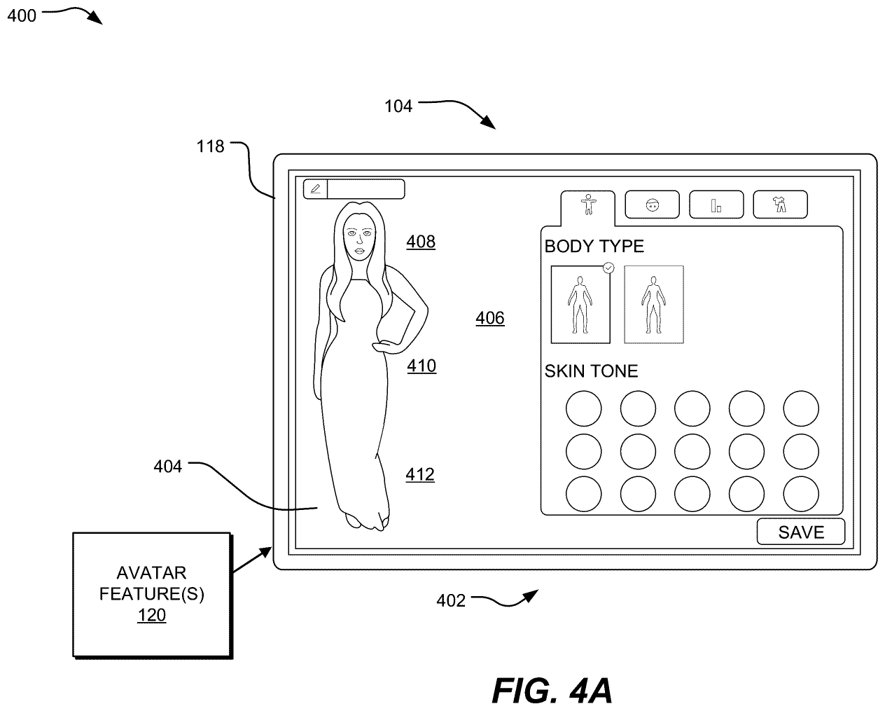

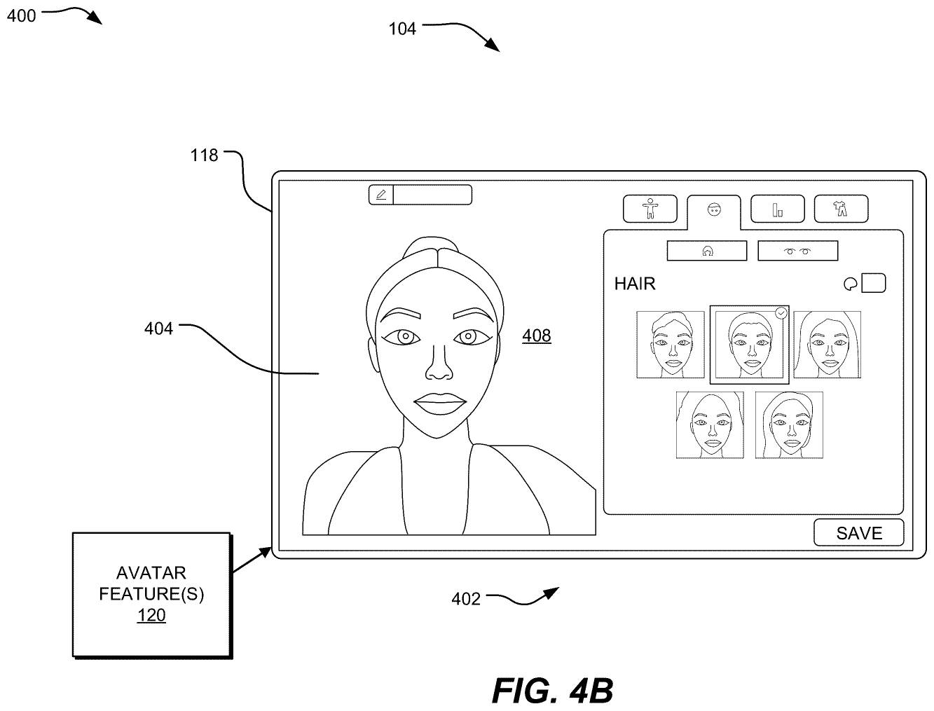

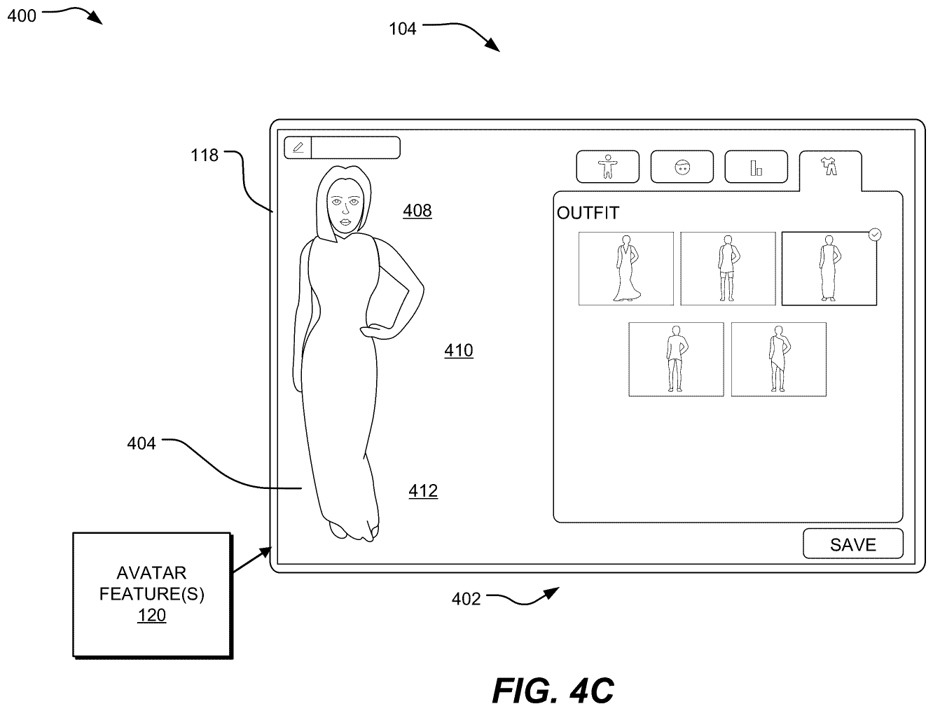

FIGS. 4A-4C depicts an example system 400 including the customizable 3D virtual environment 104 created by the environment generator engine 102. As depicted in FIGS. 4A-4C, the template user interface 106 can include an avatar settings customization engine 402 for defining the avatar creation parameters for the customizable 3D virtual environment 104. The system 400 depicted in FIGS. 4A-4C can be similar to, identical to, and/or can form at least a portion of the system 100 depicted in FIG. 1.

In some examples, the avatar settings customization engine 402 can be used by the moderator computing device 108 to establish the avatar feature(s) 114 which will be presented to the guest computing device 118. A button or other interactive UI feature can be selected to cause the environment generator engine 102 to present one or more avatar creation interface(s) 404 from another UI of the environment generator engine 102 (e.g., a UI presenting the computer-generated 3D space 124). In some examples, the moderator computing device 108 can provide inputs to the avatar creation interface(s) 404 to set the customizable parameters 110 which define different sets of avatar features. For instance, a set of mutable avatar parameter(s), which are adjustable/changeable with the avatar settings customization engine 402 can be defined by the customizable parameters 110. Another set of immutable avatar parameters, which are constant and/or unchangeable can also be defined by the customizable parameters 110. As such, different parameters of the avatar's appearance can be designated as part of the set of mutable avatar customization parameter(s) or the set of immutable avatar parameters. These two sets of avatar parameters can at least partly define an avatar template profile which can be presented to the guest computing device 118 as one of the interactive features 112. The avatar template profile can be associated with a particular entity (e.g., a particular merchant) and/or device(s) accessing the computer-generated 3D space 124 associated with the particular entity, such that all the avatars created for one moderator can have a consistent theme, and other avatars for another moderator can have a different theme. For instance, a first entity can be associated with a first avatar template profile corresponding to a type of entity of the first entity. This first entity type can be a cosmetics merchant type of entity, and the first avatar template profile for this entity can define the set of mutable avatar parameters to include one or more of makeup location, makeup styles, makeup colors, facial features, hairstyles, or skin tones. Additionally or alternatively, the first avatar template profile can define the set of immutable avatar parameters to include one or more of a body shape or a degree of realism. Furthermore, a second entity can be associated with a second avatar template profile corresponding to a second type of entity, such as a clothing merchant entity type. In some scenarios, the second avatar template profile for this entity can define the set of mutable avatar parameters to include one or more of body shape, skin tone, or facial features. Additionally or alternatively, the second avatar template profile can define the immutable customization product information database(s) 130 to include a makeup style or a degree of realism. As such, the different avatar template profiles associated with the different entities (e.g., merchants or moderators) or entity types can have different style-related parameters defined as mutable or immutable, with some style parameters being mutable for some avatar template profiles for some companies, and those same style parameters being immutable for other avatar template profiles of other companies.

In some scenarios, the avatar settings customization engine 402 can provide customization for one or more avatar creation interfaces 404 of the customizable 3D virtual environment 104. For instance, the avatar creation interfaces 404 can include an item carousel interface 406. The item carousel interface 406 can include different item portions designated to different subsets of avatar features 114. For instance, a first item portion 408 of the item carousel interface 406 can correspond to a first set of upper avatar features (e.g., at a head, neck, and/or face), such as hats, jewelry, hair styles, facial features, make up, tattoos, or combinations thereof. A second item portion 410 of the item carousel interface 406 can correspond to a second set of middle avatar features (e.g., a torso, arms, hands, fingers, or combinations thereof), such as shirts, jackets, coats, sweatshirts, blouses, bras, dresses, vests, underwear, tattoos, body types, or combinations thereof. A third item portion 412 of the item carousel interface 406 can correspond to a third set of lower avatar features (e.g., at a waist, legs, feet, toes, or combinations thereof), such as pants, shorts, dresses, underwear, skirts, socks, leggings, shoes, tattoos, or combinations thereof. It is to be understood that the item carousel interface 406 can include any number of item portions corresponding to any number of different avatar features, such as a plurality of different upper avatar features, a plurality of different middle avatar features, and/or a plurality of different lower avatar features. These different configurations can be set by the moderator computing device 108 via the customizable parameters 110.

For instance, any of the items, products, or other avatar features 114 used by the avatar settings customization engine 402 can be provided to the template user interface 106 by the moderator computing device 108 for instance, as the different inputs 126 from different data sources 128. For example, the moderator computing device 108 can upload images, 3D models 136, or other content files 134 associated with the different sets of avatar features and can define which items form which sets of avatar features for the different portions of the item carousel interface 406.

In some instances, the avatar settings customization engine 402 can include multiple interfaces that can be selected via one or more tabs. For instance, as shown in FIG. 4A, one tab of a plurality of tabs can correspond to a body type. As shown in FIG. 4B, another tab of the plurality of tabs can correspond to a hair style. As shown in FIG. 4C, an additional tab of the plurality of tabs can correspond to an outfit. Other tabs can correspond to other characteristics of the avatar 116, such as a makeup configuration, a particular facial feature, and/or an article of clothing in the first item portion 408, the second item portion 410, or the third item portion 412 of the item carousel interface 406.

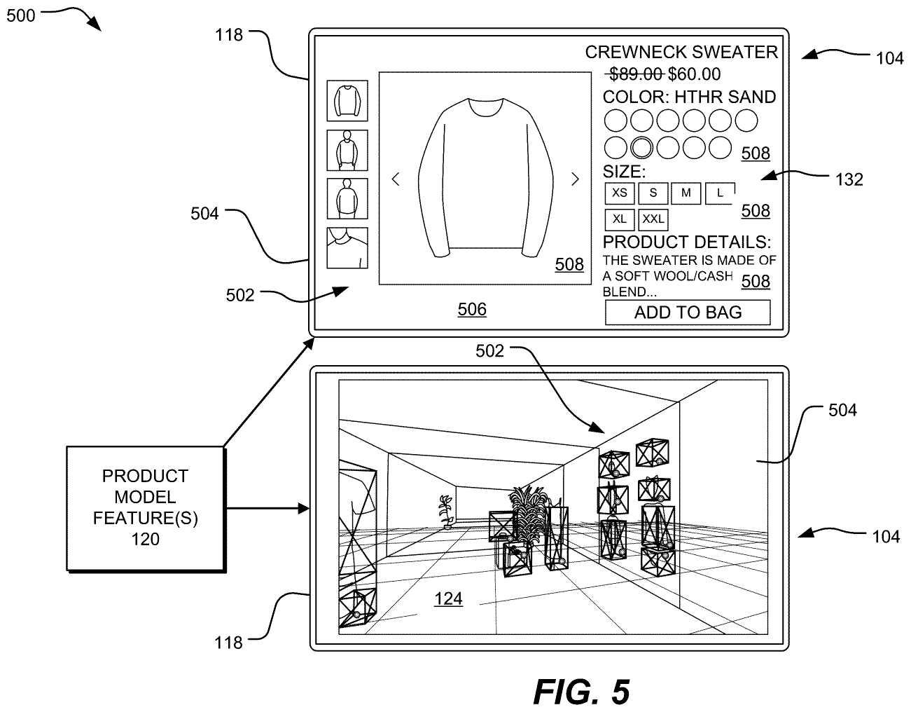

FIG. 5 depicts an example system 500 including the customizable 3D virtual environment 104 created by the environment generator engine 102. As depicted in FIG. 5, the customizable parameters 110 can include one or more product model parameters 502 to define the product model feature(s) 120. The system 500 depicted in FIG. 5 can be similar to, identical to, and/or can form at least a portion of the system 100 depicted in FIG. 1.

In some examples, the product model parameters 502 can include the product information 132 pulled from the product information database(s) 130 in any of the formats discussed herein (e.g., 3D model files, image files, video files, audio files, etc.). The customizable parameters 110 defining product model feature(s) 120 can be determined by the content file(s) 134, which can further include hyper realistic virtual 3D objects (e.g., product models) to accurately depict fabric, textures, colors, and other visual aspects of the products presented in the customizable 3D virtual environment 104. The content file(s) 134 can be associated and/or linked to the product information 132 in the database(s) 130, such that an interaction with the product model within the computer-generated 3D space 124 can cause the system 500 to retrieve and/or present the product information 132 at the display 504 of the guest computing device 118. Defining the customizable parameters 110 at the moderator computing device 108 can also include mapping the content file(s) 134 can to various surfaces of the rendered reconstruction of the 3D model 136 (e.g., a wall, a clothes rack, a table, a counter, a display stand, etc.), for instance, by selecting one or more location coordinates and/or dragging and dropping the product model. The customizable parameters 110 can also include configuration inputs at the moderator computing device 108 to establish or adjust an angle of presentation for product models, which can stay facing the avatars 116 as the avatars 116 moves about the computer-generated 3D space 124.

In some examples, the product model features 120 can include one or more user interface layouts 506 which present the product information 132 responsive to the user input(s) 210. For instance, the customizable parameters 110 can include a size, shape, and/or position of one or more product information sections 508 overlayed onto the computer-generated 3D space 124. Furthermore, the customizable parameters 110 can include particular text, images, videos, and/or other content file(s) 134 presented in the one or more product information sections 508 responsive to inputs at the interactive features 112 (e.g., the product models) in the customizable 3D virtual environment 104.

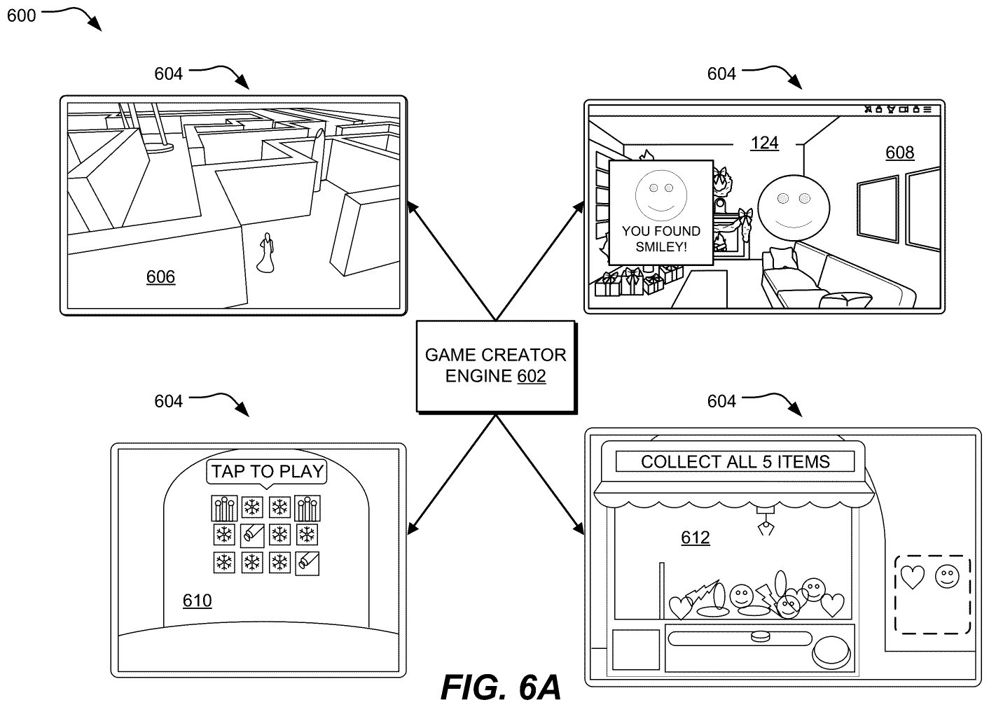

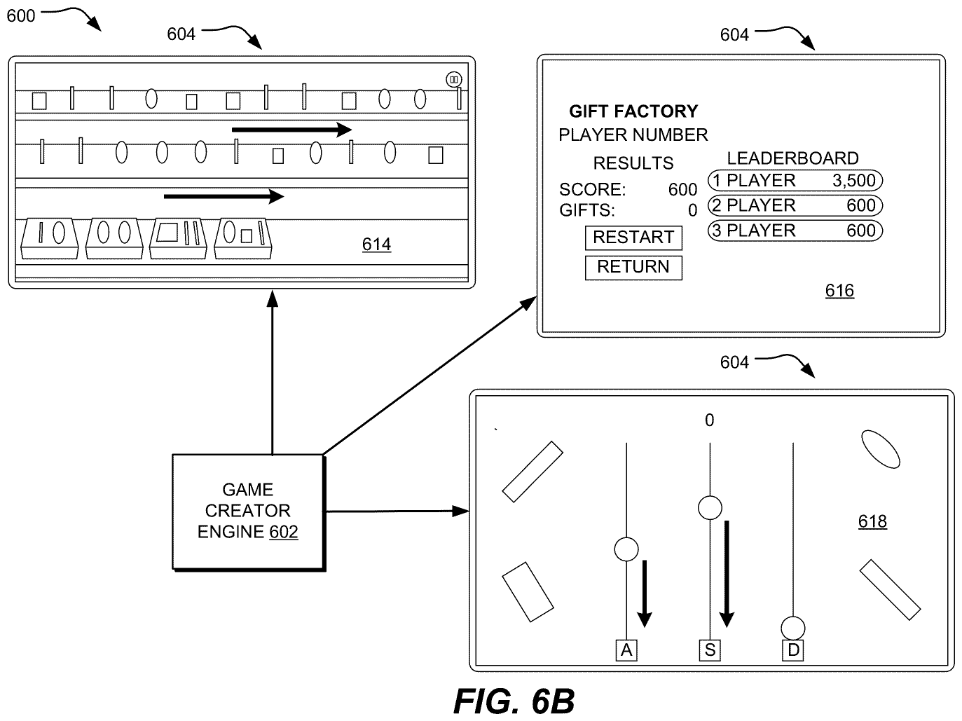

FIGS. 6A and 6B depicts an example system 600 including the customizable 3D virtual environment 104 created by the environment generator engine 102. As depicted in FIGS. 6A and 6B, the environment generator engine 102 can include a game creator engine 602 for defining the interactive features 112 of one or more games 604 integrated into the customizable 3D virtual environment 104. The system 600 depicted in FIGS. 6A and 6B can be similar to, identical to, and/or can form at least a portion of the system 100 depicted in FIG. 1.

Turning to FIG. 6A, in some instances, the game creator engine 602 can be used, by the merchant system(s) 202 to select a type of game to be implemented by (e.g., layered onto) the customizable 3D virtual environment 104. The one or more games 604 can be a wide variety of games, such as a maze type of game 606, a scavenger hunt type of game 608, a tile-flipping memory type of game 610, a claw-machine type of game 612, and/or combinations thereof.

By way of example, the game(s) 604 can include the maze type of game 606 with customizable parameters 110 that define the game features 122 of the maze. These game features 122 can include one or more starting locations for the avatars 116, one or more correct maze routes, one or more false maze routes, one or more final destinations (e.g., a maze center), a visual indicator associated with a successful completion of the maze type of game 606, and so forth. Furthermore, the game features 122 can include one or more modes of mobility for the avatars 116, such as walking, running, riding a virtual scooter, driving a virtual car, etc. As noted above, any of these game features 122 can correspond to the content file(s) 134 uploaded by the moderator computing device 108. For instance, a particular entity associated with the moderator computing device 108 may be a scooter company, and the mode of mobility can include a particular virtual model of a scooter uploaded by the entity.

Furthermore, the one or more games 604 can include the scavenger hunt type of game 608 in which the customizable parameters 110 include items (e.g., coins, butterflies, jewels, etc.) dispersed throughout the computer-generated 3D space 124, such that avatars 116 can explore the 3D space 124 attempting to find/collect the items. In some instances, a prompt or other type of content (e.g., video, animation, text, song, audio, or so forth) can be presented to the guest computing device 118 of the guest system 204 in response to finding or selecting the item(s). The content can be retrieved from the product information database(s) 130 of the merchant system 202. Furthermore, a progress indicator can be displayed at the user device of the guest system 204, which can fill in with a color to indicate an amount of items found. In some instances, the item can be a static image (e.g., of a butterfly) that transforms into an animation (e.g., the butterfly flying away) upon being found or selected. The inputs 126 provided to the game creator engine 602 to set the customizable parameters 110 can determine the game feature(s) 122 of the scavenger hunt type of game 608, such as an item image/model/animation, a customizable prize for completing the scavenger hunt (e.g., a discount, a free product, entry into a raffle, and so forth), a number of items to be found, locations of the items, response messages/outputs for finding the items such as an uploaded animation (e.g., sparkles, a diamond animation, text, etc.), and/or a visual indicator associated with a successful completion of the scavenger hunt type of game 608. By way of example, the scavenger hunt type of game 608 can be combined with other game types, such as the maze type of game 606.

Additionally, the one or more games 604 can include the tile-flipping memory game 610. This game 604 can include a plurality of interactive tiles having a common image on one side, and pairs of differing images randomly distributed throughout their other sides. The game features 122 for the tile-flipping memory game defined by the customizable parameters 110 can include a number of tiles, the common image, the pairs of differing images, and/or one or more visual indicators of a prize associated with successful completion of the tile-flipping memory game. Furthermore, the tile-flipping memory game 610 can get progressively more difficult by increasing a number of tiles whenever one set of tiles is completed, such as progressing from a 4×4 grid of tiles to an 8×8 grid of tiles. The amount of tiles by which the game 604 increases can also be based on the inputs 126 provided by the moderator computing device 108.

The one or more games 604 can also include the claw-machine type of game 612. This game 604 can include a plurality of prize objects represented by images and/or 3D models and a controllable claw that, responsive to the input(s) 210 at the guest computing device 118, moves along one or two axes. Responsive to a trigger input from the guest computing device 118, the claw can release in an attempt to grab one of the plurality of prize objects. The game features 122 controlled by the customizable parameters 110 can include a plurality of images or virtual objects forming the prize objects (e.g., uploaded by the 108), a number of prize objects, a claw accuracy/difficulty level, and/or a visual indicator associated with a successful completion of the claw-machine type of game 612.

In some examples, the game creator engine 602 can receive other inputs 126 from the moderator computing device 108 to establish the interactive features 112 of the game(s) 604, additionally or alternatively to those discussed above. These game features 122 can include a location of the game 604 in the 3D space 124, time limits for game play, numbers of items, prompt triggers, prompt content (e.g., hints), availability dates for when the game can be accessed, and/or combinations thereof.

Turning to FIG. 6B, the one or more games 604 can further include a factory packaging game 614, a leader board interface 616, and/or a catching game 618.

In some examples, the factory packaging game 614 can include one or more rows of items (e.g., a first row and a second row) which move from one side of the screen to another, mimicking a conveyor belt in a factory setting. A user can be tasked with clicking or touching particular items of the row of items that match cut-out openings in one or more packages, which can be located in the user interface below the rows of items. Upon selecting the correct items which match each of the cut outs in each of the boxes, the round can be completed. In this game type, many of the game features 122 can be interactive features 112 based on customizable parameters 110 provided by the moderator computing device 108. For instance, the items forming the row of items can be customized by the moderator to include product models, product model feature 120, or other product information 132. Moreover, the cut-out openings in the packages being filled can also be customized by the moderator to include their product information 132. Additionally game features 122 that can be customized include the number of items per package, the number of packages, the speed at which the rows of items move across the screen, and/or a number of rows of items.

In some scenarios, the game creator engine 602 can generate the leaderboard interface 616 showing a player's score, how that player's score compares to previous scores, a restart button, and/or a return button. These components of the leader board interface 616 can slow be interactive features 112 based on customizable parameters 110 indicating a number of previous scores presented, a scoring schema, and so forth.

Additionally, the game creator engine 602 can generate the catching game 618. The catching game 618 can include one or more lines (e.g., vertical lines) along which a plurality of icons rapidly move (e.g., “fall”). Each line can correspond to a particular keyboard button which a user attempts to press at an exact time that the falling items reach the bottom of the vertical line. The user can score points when they press the correct button at the right time. In this game, customizable interactive features 112 can include the number of vertical lines, the speed at which the items fall, a shape of the falling items (e.g., to match a product shape), and/or background products which can light up whenever the user scores a point.

FIG. 7 depicts an example system 700 including the customizable 3D virtual environment 104 created by the environment generator engine 102. As depicted in FIG. 7, the customizable parameters 110 can be set to define various environment feature(s) 123 which form the computer-generated 3D space 124. The system 700 depicted in FIG. 7 can be similar to, identical to, and/or can form at least a portion of the system 100 depicted in FIG. 1.

In some examples, the environment feature(s) 123 can include the visual and/or structural components that constitute the computer-generated 3D space 124. For example, the moderator computing device 108 can upload any type of 3D model 136 for generating the virtual environment, such as a primitive model, a polygon model, a rational B-Spline model, a Non-Uniform Rational Basis Spline (NURBS) model, a Computer Aided Design (CAD) model, a solid model, a wireframe model, a surface model, combinations thereof, and so forth. The 3D model 136 can be rendered at the guest computing device 118, for instance by generating one or more cube maps from the 3D model (e.g., a reconstructed rendering), to create the computer-generated 3D space 124. In some instances, the 3D model 136 represents a virtual structure such as a virtual building and the computer-generated 3D space 124 can be an exterior and/or an inside of the virtual building. For instance, the computer-generated 3D space 124 can include one or more rooms 702 in the virtual building. Moreover, one or more surface layer(s) 704 can be uploaded by the moderator computing device 108 to customize the computer-generated 3D space 124 by layering over the 3D model reconstructed rendering. The surface layer(s) 704 can include one or more of a light source layer, reflective material layer, a texture layer, combination thereof, and so forth. The environment feature(s) 123 can also include one or more personalization features based on a user preference. These personalization features can include a light color theme, a dark color theme, a daytime environment, a nighttime environment, an indoor scene, an outdoor scene, and/or combinations thereof. Furthermore, the personalization features can be based on user data associated with the guest computing device 118 and or a user profile so that personal data can be integrated into the customizable 3D virtual environment 104, such as a personal photo, a personal video, a name (e.g., such as a “Welcome, Susie!” banner), and so forth.

In some examples, the customizable parameters 110 which customize, modify, and/or change the environment feature(s) 123 can be provided via the inputs 126 at a drop down menu to select a type of scene model, such as a fully navigable 3D scene, a cube map-based scene with incremented viewpoints, or a combination of both. Additionally or alternatively, the one or more inputs 126 can provide the 3D model 136 to a file uploader; select or modify an environment outer boundary shape; or specify a type of lighting. For instance, the template user interface 106 can receive an input 126 selecting an ambient light for the 3D space 124 that illuminates the entire 3D model 136, a particular light color and/or intensity, directional light which can illuminate a portion or sub region of the 3D model 136, and/or combinations thereof. Furthermore, the template user interface 106 can receive one or more inputs 126 causing the customizable parameters 110 to set one or more scene controls, such as a navigational angle limit (e.g., an angle limit for looking up or down), a start angle, and/or a start zoom level. Furthermore, the customizable parameters 110 can indicate whether some or all of the interactive features 112 comprise AR features to be overlayed over an environment input (e.g., a video or an image), indicating a real-world spatial surrounding of the one or more guest computing device 118, in an AR environment. The environment inputs can be received from one or more sensors of the guest computing device 118 (e.g., one or more camera(s) and/or motion sensor(s)).

In some scenarios, the customizable parameters 110 can customize a portion of the computer-generated 3D space 124, for instance, to personalize one of the rooms 702 of the virtual building. The template user interface 106 can receive the one or more inputs 126 from the moderator computing device 108 to personalize the room 702 for a particular user (e.g., associated with a particular identifier corresponding to the guest system 204 and/or the guest computing device 118). By way of example, the customized room can include a customized message, customized content file(s) 134, a customized lighting theme or style theme, or the like, which can be layered over the computer-generated 3D space responsive to determining that the particular guest device (e.g., or avatars 116 associated with the particular guest device) is navigating the computer-generated 3D space 124 and/or logged into the customized 3D virtual environment 104.

In some examples, the customizable parameters 110 can include a mapping coordinate layer comprising a plurality of 3D mapping coordinates corresponding to specific locations, surfaces, or features in the computer-generated 3D space 124. Furthermore, using the environment generator engine 102, the template user interface 106 can receive the one or more inputs 126 from the moderator computing device 108 selecting one or more of the 3D mapping coordinates for placement of the content file(s) 134. For instance, one or more content file(s) 134 can be dragged and dropped onto a visual representation of the computer-generated 3D space 124 at one or more locations. The 3D mapping coordinates corresponding to these locations can be associated with the content file(s) 134, such that the content file(s) 134 are retrieved and rendered at the locations of the 3D mapping coordinates upon rendering the reconstructions of the 3D model 136 (e.g., one or more cube map representations of the 3D model 136).

By using the techniques discussed herein to combine the 3D model(s) 136 with content file(s) 134 defining the interactive features 112, the environment generator engine 102 can render the computer-generated 3D space 124 in an efficient manner using minimal computational resources. These techniques can also include a zoom in and/or zoom out feature using a mouse input device, arrow keys, a tracker, and/or a touchscreen associated with the guest computing device 118 presenting the computer-generated 3D space 124. Additionally, the computer-generated 3D space 124 can be navigable by the avatars 116 with complete freedom of continuous movement in any direction within the computer-generated 3D space 124 while providing a high level of detail and multiple engaging features.

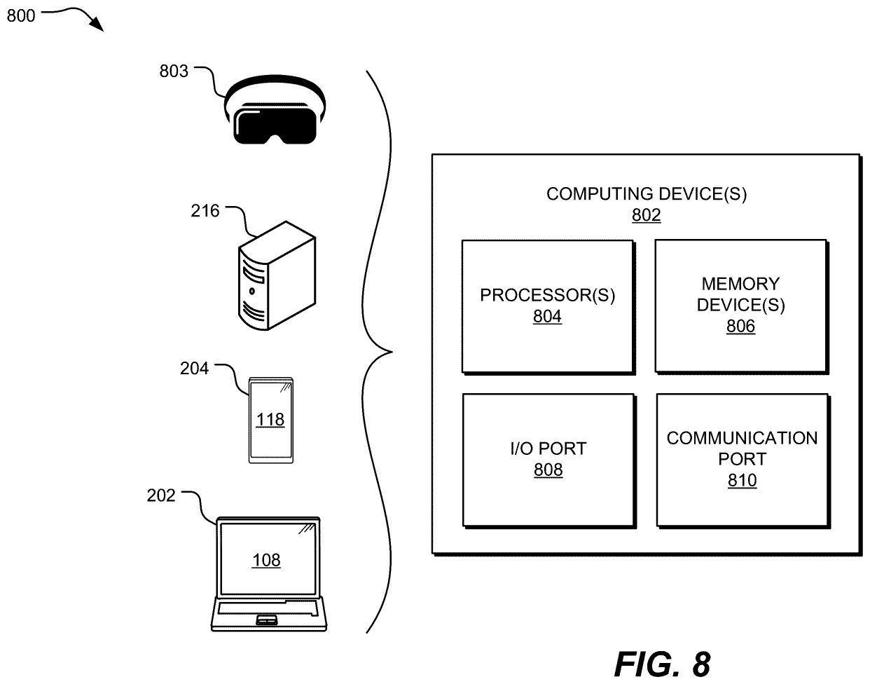

FIG. 8 depicts an example system 800 including the customizable 3D virtual environment 104 created by the environment generator engine 102. The system 800 can include one or more computer device(s) 802 which can implement the systems 100-700 and/or perform the method(s) 900 discussed herein. The system 800 depicted in FIG. 8 can be similar to, identical to, and/or can form at least a portion of the system 100 depicted in FIG. 1.

In some instances, the one or more computing device(s) 802 can include the moderator computing device 108 and/or other devices of the merchant systems 202; the guest computing device 118 and/or other devices of the guest systems 204, the server device(s) 216, or any other devices discussed throughout this disclosure. The computing device(s) 802 can include a computer, a personal computer, a desktop computer, a laptop computer, a terminal, a workstation, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) (e.g., a VR headset 803) or augmented reality (AR) device, a vehicle (e.g., a smart bicycle, an automobile computer, etc.), combinations thereof, and/or the like. For instance, the guest computing device 118 can be a VR headset to access the customizable 3D virtual environment in a VR space.

The computing device 802 may be a computing system capable of executing a computer program product to execute a computer process. The environment generator engine 102 can be stored and executed at the computing device(s) 802 (e.g., as one or more software components, algorithm modules, or so forth). Data and program files may be input to the computing device 802 which reads the files and executes the programs therein to provide the various components of the environment generator engine 102 and generate the customizable 3D virtual environment 104. Some of the elements of the computing device 802 include one or more hardware processors 804, one or more memory devices 806, and/or one or more ports, such as input/output (IO) port(s) 808 and communication port(s) 810. Various elements of the computing device 802 may communicate with one another by way of the communication port(s) 810 and/or one or more communication buses, point-to-point communication paths, or other communication means.

The processor 804 may include, for example, a central processing unit (CPU), a microprocessor, a microcontroller, a digital signal processor (DSP), a graphics processing unit (GPU) and/or one or more internal levels of cache. There may be one or more processors 804, such that the processor 804 comprises a single central-processing unit, or a plurality of processing units capable of executing instructions and performing operations in parallel with each other, commonly referred to as a parallel processing environment.

The computing device 802 may be a standalone computer, a distributed computer, or any other type of computer, such as one or more external computers made available via a cloud computing architecture. The presently described technology is optionally implemented in software stored on the data storage device(s) such as the memory device(s) 806, and/or communicated via one or more of the ports 808 and 810, thereby transforming the computing device 802 in FIG. 8 to a special purpose machine for implementing the operations of the environment generator engine 102.

The one or more memory device(s) 806 may include any non-volatile data storage device capable of storing data generated or employed within the computing device 802, such as computer executable instructions for performing a computer process, which may include instructions of both application programs and an operating system (OS) that manages the various components of the computing device 802. The memory device(s) 806 may include, without limitation, magnetic disk drives, optical disk drives, solid state drives (SSDs), flash drives, and the like. The memory device(s) 806 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 806 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 806 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 802 includes one or more ports, such as the I/O port 808 and the communication port 810, for communicating with other computing, network, or vehicle devices. It will be appreciated that the I/O port 808 and the communication port 810 may be combined or separate and that more or fewer ports may be included in the computing device 802.

The I/O port 808 may be connected to an I/O device, or other device, by which information is input to or output from the computing device 802. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 802 via the I/O port 808. Similarly, the output devices may convert electrical signals received from the computing device 802 via the I/O port 808 into signals that may be sensed as output by a human, such as sound, light, and/or touch. The input device may be an alphanumeric input device, including alphanumeric and other keys for communicating information and/or command selections to the processor 804 via the I/O port 808. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In some scenarios, the computing device 802 can receive one or more inputs or combinations of inputs corresponding to actions in the customizable 3D virtual environment 104. For instance, particular combinations of buttons on a handheld controller can provide the navigation inputs 212 to cause the avatar 116 to move, and/or to interact with the various interactive features 112. Additionally or alternatively, the I/O port 808 can use one or more cameras and/or motion sensors to detect a hand gesture (e.g., swipe) or body gesture, which can be converted into the navigation inputs 212 or the interaction with the interactive features 112. Moreover, the I/O port 808 can detect a gaze direction and/or duration, which can be compared to a predetermined threshold time, to determine a hover state selection input.

Furthermore, the computing device 802 can include an environment transducer device to convert one form of energy or signal into another for input into or output from the computing device 802 via the I/O port 808. For example, an electrical signal generated within the computing device 802 may be converted to another type of signal, and/or vice-versa. In one implementation, the environment transducer device can sense characteristics or aspects of an environment local to or remote from the computing device 802, such as, light, sound, temperature, physical movement, orientation, acceleration, gravity, and/or the like.

In one implementation, the communication port 810 is connected to the network 206 and the computing device 802 may receive network data useful in executing the methods and systems set out herein as well as transmitting information and network configuration changes determined thereby. Stated differently, the communication port 810 can connect the computing device 802 to one or more communication interface devices configured to transmit and/or receive information between the computing device 802 and other devices by way of one or more wired or wireless communication networks or connections. Examples of such networks 206 or connections can include, without limitation, Universal Serial Bus (USB), Ethernet, Wi-Fi, Bluetooth®, Near Field Communication (NFC), and so on. One or more such communication interface devices may be utilized via the communication port 810 to communicate one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 810 may communicate with an antenna or other link for electromagnetic signal transmission and/or reception.

In an example implementation, the environment generator engine 102 may be embodied by instructions stored on the memory devices 806 and executed by the processor 804.

The system 800 set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 802.

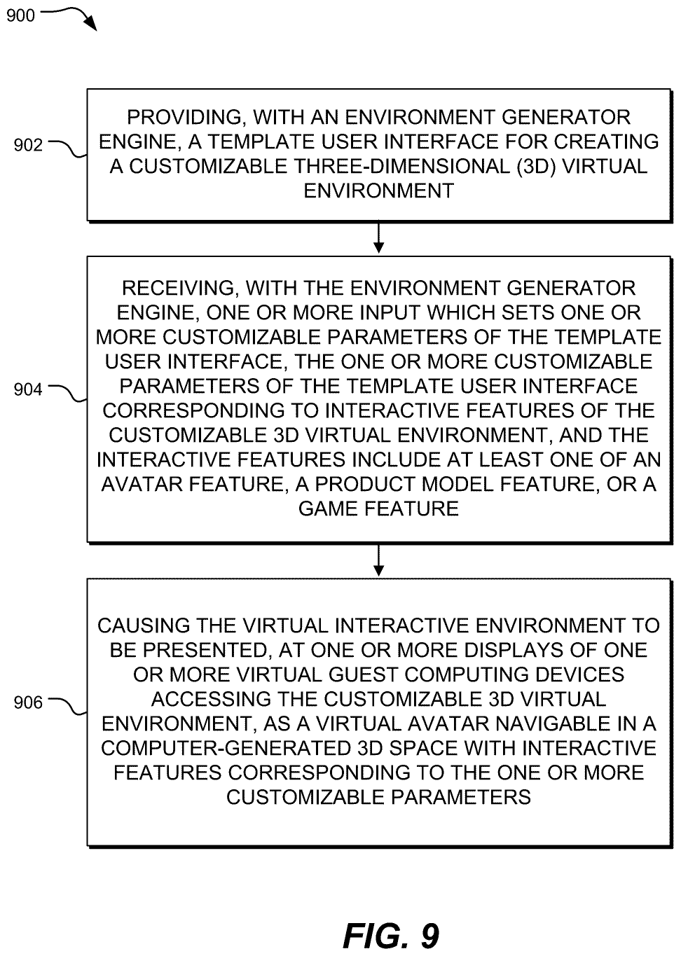

FIG. 9 illustrates an example method 900 to provide the customizable 3D virtual environment 104 using the environment generator engine 102, which can be performed by any of the systems 100-800.

In some examples, at operation 902, the method 900 provides, with an environment generator engine, a template user interface for creating a customizable three-dimensional (3D) virtual environment. At operation 904, the method 900 receives, with the environment generator engine, one or more input which sets one or more customizable parameters of the template user interface, the one or more customizable parameters of the template user interface corresponding to interactive features of the customizable 3D virtual environment, and the interactive features include at least one of an avatar feature, a product model feature, or a game feature. At operation 906, the method 900 causes the virtual interactive environment to be presented, at one or more displays of one or more guest computing devices accessing the customizable 3D virtual environment, as a virtual avatar navigable in a computer-generated 3D space with the interactive features corresponding to the one or more customizable parameters

It is to be understood that the specific order or hierarchy of steps in the method 900 depicted in FIG. 9 or throughout this disclosure are instances of example approaches and can be rearranged while remaining within the disclosed subject matter. For instance, any of the operations depicted in FIG. 9 or throughout this disclosure may be omitted, repeated, performed in parallel, performed in a different order, and/or combined with any other of the operations depicted in FIG. 9 or throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method to provide a virtual interactive environment, the method comprising:
providing, with an environment generator engine, a template user interface for creating a customizable three-dimensional (3D) virtual environment;
receiving, with the environment generator engine, one or more input which sets one or more customizable parameters of the template user interface, the one or more customizable parameters of the template user interface corresponding to interactive features of the customizable 3D virtual environment, and the interactive features include at least one of an avatar feature, a product model feature, or a game feature; and
causing the virtual interactive environment to be presented, at one or more displays of one or more guest computing devices accessing the customizable 3D virtual environment, as a virtual avatar navigable in a computer-generated 3D space with the interactive features corresponding to the one or more customizable parameters.

2. The method of claim 1, further comprising:
receiving a navigation-specific input; and
cycling between a plurality of predefined location coordinates of the customizable 3D virtual environment responsive to the navigation-specific input.

3. The method of claim 2, further comprising:
presenting a mini-map portion at a graphical user interface (GUI) of the one or more guest computing devices;
detecting an interaction with the mini-map portion of the GUI; and
cause an avatar location to change to a predefined location coordinate corresponding to the interaction with the mini-map portion of the GUI.

4. The method of claim 2, wherein the one or more customizable parameters control the interactive features including a 3D model rendered to form a virtual structure, a virtual building, or a virtual room, the 3D model defining the computer-generated 3D space of the customizable 3D virtual environment.

5. The method of claim 4, wherein the environment generator engine receives the one or more input at a moderator computing device which hosts the computer-generated 3D space for the one or more guest computing devices accessing the customizable 3D virtual environment.

6. The method of claim 1, wherein the one or more customizable parameters includes one or more product models mapped to one or more virtual surfaces of the computer-generated 3D space.

7. The method of claim 6, wherein the one or more product models include a link which, responsive to receiving a user interaction, causes a computing device hosting the customizable 3D virtual environment to:
retrieve product data related to the one or more product models stored at a product information database; and
cause the product data to be presented at the one or more guest computing devices overlayed onto the customizable 3D virtual environment.

8. The method of claim 1, wherein the one or more customizable parameters control one or more of a lighting source layer, a reflective material layer, or a texture layer mapped to a 3D model to define the computer-generated 3D space.

9. The method of claim 8, wherein the one or more customizable parameters include a first set of avatar customization parameters selected to be mutable by the one or more input, and a second set of avatar customization parameters selected to be immutable by the one or more input.

10. A system for providing a virtual interactive environment, the system comprising:
one or more processors; and
a computer-readable memory device storing instructions that, when executed by the one or more processors, cause the system to:
provide, with an environment generator engine, a template user interface for creating a customizable computer-generated three-dimensional (3D) virtual environment;
receive, with the environment generator engine, one or more input which sets one or more customizable parameters of the template user interface, the one or more customizable parameters of the template user interface corresponding to a plurality of interactive features of the customizable 3D virtual environment, and the plurality of interactive features include an avatar feature, a product model feature, and a game feature; and
cause the virtual interactive environment to be presented, at one or more displays of one or more guest computing devices accessing the customizable 3D virtual environment, as a virtual avatar navigable in a computer-generated 3D space with the plurality of interactive features corresponding to the one or more customizable parameters.

11. The system of claim 10, wherein the instructions, when executed by the one or more processors, further cause the system to:
receive an environment input from one or more sensors of the one or more guest computing devices, the environment input indicating a real world spatial surrounding of the one or more guest computing devices, the computer-generated 3D space representing the environment input overlayed with the plurality of interactive features.

12. The system of claim 10, wherein the game feature includes a tile-flipping memory game integrated into the customizable 3D virtual environment, and the one or more customizable parameters further include:
a number of tiles of the tile-flipping memory game;
one or more images disposed on one or more tiles of the tile-flipping memory game; and
a visual indicator of a prize associated with successful completion of the tile-flipping memory game.

13. The system of claim 10, wherein the game feature includes a virtual claw-machine game integrated into the customizable 3D virtual environment, and the one or more customizable parameters include:
a plurality of images or virtual objects, corresponding to a plurality of virtual prizes; and
a visual indicator associated with a successful completion of the virtual claw-machine game.

14. The system of claim 10, wherein the game feature includes a virtual scavenger hunt game integrated in the customizable 3D virtual environment, and the one or more customizable parameters include:
one or more images or objects uploaded to the environment generator engine;
one or more hidden object locations coordinates, selected with the one or more input, associated with the one or more images or objects; and
a visual indicator associated with a successful completion of the virtual scavenger hunt game.

15. A system for providing a virtual interactive environment, the system comprising:
one or more processors; and
a computer-readable memory device storing instructions that, when executed by the one or more processors, cause the system to:
provide, with an environment generator engine, a template user interface for creating a customizable computer-generated three-dimensional (3D) virtual environment;
receive, with the environment generator engine, one or more input which sets a plurality of customizable parameters of the template user interface, the plurality of customizable parameters of the template user interface corresponding to a plurality of interactive features of the customizable 3D virtual environment; and
cause the virtual interactive environment to be presented, at a plurality of displays of a plurality of guest computing devices accessing the customizable 3D virtual environment, as a plurality of different virtual avatars corresponding to the plurality of guest computing devices, the plurality of different virtual avatars being navigable in a computer-generated 3D space of the computer-generated 3D virtual environment including the plurality of interactive features.

16. The system of claim 15, wherein the template user interface includes an avatar customization parameters interface representing different portions of an avatar, and the plurality of customizable parameters include customized sets of selectable avatar features that correspond to the different portions of the avatar.

17. The system of claim 15, wherein the plurality of interactive features include a guide avatar and the plurality of customizable parameters include one or more of:
one or more images or objects associated with product data, uploaded to the environment generator engine, for outputting by the guide avatar in the customizable 3D virtual environment responsive to an interaction with a virtual avatar of the plurality of different virtual avatars; or
one or more predefined location coordinates of the customizable 3D virtual environment for navigating the guide avatar responsive to the interaction with the virtual avatar.

18. The system of claim 15, wherein the instructions, when executed by the one or more processors, further cause the system to:
determine a user preference from a database storing user profile information associated with a user of a guest computing device; and
determine a customizable parameter based at least partly on the user preference, the customizable parameter corresponding to a content file rendered at a surface in the customizable 3D virtual environment.

19. The system of claim 15, wherein the instructions, when executed by the one or more processors, further cause the system to:
create, using a generative AI content engine, a plurality of selectable options for a customizable parameter, the template user interface including a user interface portion presenting the plurality of selectable options.

20. The system of claim 19, wherein the plurality of selectable options define a customizable parameter which determines a 3D model virtual building structure, a room arrangement, a color scheme, a wallpaper design, a surface texture, a virtual architectural features, or a lighting arrangement.
